(19) United States
(12) Patent Application Publication
(10) Pub. No.: US 2021/0383287 A1
(43) Pub. Date: Dec. 9, 2021

(54) INFORMATION PROCESSING DEVICE, PROGRAM, AND INFORMATION PROCESSING METHOD

(71) Applicant: Toyota Jidosha Kabushiki Kaisha, Toyota-shi Aichi-ken (JP)

(72) Inventors: Tsuyoshi Andou, Toyota-shi (JP); Akitoshi Jikumaru, Nisshin-shi (JP); Ryosuke Kobayashi, Nagakute-shi (JP); Tomokazu Maya, Nagoya-shi (JP); Masatoshi Hayashi, Nisshin-shi (JP)

(73) Assignee: Toyota Jidosha Kabushiki Kaisha, Toyota-shi Aichi-ken (JP)

(21) Appl. No.: 17/216,009

(22) Filed: Mar. 29, 2021

(30) Foreign Application Priority Data
Jun. 3, 2020 (JP) 2020-096937

(51) Int. Cl. G06Q 10/06

(52) U.S. Cl. CPC G06Q 10/0631

(57) ABSTRACT

An information processing device includes a communication unit and a control unit. The control unit identifies, based on application information received by the communication unit for applying for use of a vehicle, a user that has applied for the use of the vehicle. The control unit determines a vehicle to be recommended to the user among a plurality of vehicles based on preference information and smell information, the preference information indicating a degree of preference of the user for a smell of a plurality of classifications, and the smell information indicating a smell classification of each of the vehicles.

### CROSS-REFERENCE TO RELATED APPLICATION

This application claims priority to Japanese Patent Application No. 2020-096937 filed on Jun. 3, 2020, incorporated herein by reference in its entirety.

### BACKGROUND

### 1. Technical Field

The present disclosure relates to information processing devices, programs, and information processing methods.

### 2. Description of Related Art

A technique for providing a platform for a car sharing service is known (for example, Japanese Unexamined Patent Application Publication No. 2016-206715 (JP 2016-206715 A)). JP 2016-206715 A describes a recommendation information management server that transmits recommendation information to a user who uses the car sharing service.

### SUMMARY

In the above technique, improvement in user convenience is desired.

An object of the present disclosure is to provide an information processing device, a program, and an information processing method that improve user convenience.

An information processing device according to an embodiment of the present disclosure includes: a communication unit; and a control unit that identifies, based on application information received by the communication unit for applying for use of a vehicle, a user that has applied for the use of the vehicle, and that determines a vehicle to be recommended to the user among a plurality of vehicles based on preference information and smell information, the preference information indicating a degree of preference of the user for a smell of a plurality of classifications, and the smell information indicating a smell classification of each of the vehicles.

A program according to another embodiment of the present disclosure causes a computer to perform operations including: receiving application information for applying for use of a vehicle; identifying a user who has applied for the use of the vehicle by the application information; and determining a vehicle to be recommended to the user among a plurality of vehicles based on preference information and smell information, the preference information indicating a degree of preference of the user for a smell of a plurality of classifications, and the smell information indicating a smell classification of each of the vehicles.

An information processing method according to another embodiment of the present disclosure includes: receiving, by an information processing device, application information for applying for use of a vehicle; identifying, by the information processing device, a user who has applied for the use of the vehicle by the application information; and determining, by the information processing device, a vehicle to be recommended to the user among a plurality of vehicles based on preference information and smell information, the preference information indicating a degree of preference of the user for a smell of a plurality of classifications, and the smell information indicating a smell classification of each of the vehicles.

According to the embodiments of the present disclosure, an information processing device, a program, and an information processing method that improve user convenience may be provided.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram showing a configuration of an information processing system according to a first embodiment of the present disclosure;

FIG. 2 is a block diagram showing a detailed configuration of the information processing system shown in FIG. 1;

FIG. 3 is a diagram showing an example of preference information according to the first embodiment of the present disclosure;

FIG. 4 is a diagram showing an example of smell information according to the first embodiment of the present disclosure;

FIG. 5 is a flowchart showing an operation of the information processing system according to the first embodiment of the present disclosure;

FIG. 6 is a diagram illustrating a concept of a model according to a second embodiment of the present disclosure; and

FIG. 7 is a flowchart showing an operation of an information processing system according to the second embodiment of the present disclosure.

### DETAILED DESCRIPTION OF EMBODIMENTS

Hereinafter, embodiments of the present disclosure will be described below with reference to the drawings. In the components shown in the drawings, the same components are designated by the same reference signs.

### First Embodiment

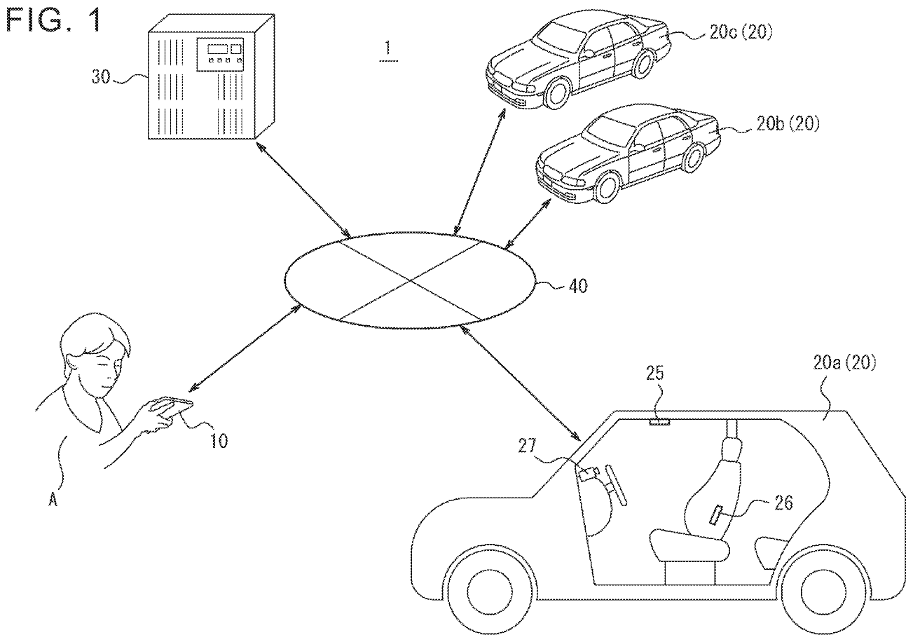

As shown in FIG. 1, an information processing system 1 according to a first embodiment of the present disclosure includes a terminal device 10, a vehicle 20a, a vehicle 20b, a vehicle 20c, and an information processing device 30.

Hereinafter, when the vehicle 20a, the vehicle 20b, and the vehicle 20c are not particularly distinguished, these are collectively referred to as “vehicle(s) 20”. FIG. 1 shows the information processing system 1 including the three vehicles 20. The number of vehicles 20 included in the information processing system 1 is not limited to three. The information processing system 1 only needs to include a plurality of vehicles 20.

The terminal device 10, the vehicles 20, and the information processing device 30 can communicate with each other via a network 40. The network 40 may be any network including a mobile communication network, the Internet, and the like.

The information processing system 1 may provide a car sharing service. The car sharing service is a service for renting a shared vehicle to a pre-registered member. The pre-registered members include, for example, user A. The shared vehicle used for car sharing is the vehicle 20.

The terminal device 10 can be used by a user. For example, the terminal device 10 can be used by the user A. The terminal device 10 can accept user input for applying for the use of the vehicle 20 in the car sharing service. That is, the user can apply for the use of the vehicle 20 in the car sharing service via the terminal device 10.

The terminal device 10 may be any device as long as it can accept user input for applying for the use of the vehicle 20. The terminal device 10 is, for example, a mobile phone, a smartphone, a tablet, a personal computer (PC), or the like. A dedicated application that provides a car sharing service may be installed in the terminal device 10.

The vehicle 20 can be used in a car sharing service. The vehicle 20 can be operated as a shared vehicle in the car sharing service. The vehicle 20 is on standby at the station when it is not being used by the user.

The vehicle 20 may be any type of automobile. The vehicle 20 is, for example, a gasoline vehicle, a diesel vehicle, a hybrid vehicle (HV), a plug-in hybrid vehicle (PHV), an electric vehicle (EV), a fuel cell vehicle (FCV), or the like. The vehicle 20 may be driven by the driver. The driving of the vehicle 20 may be automated at any level. The level of automation is, for example, one of level 1 to level 5 classified by the Society of Automotive Engineers (SAE). The vehicle 20 may be a vehicle dedicated to “Mobility-as-a-Service (MaaS)”.

The vehicle cabin of the vehicle 20 can be a closed space. Since the vehicle cabin of the vehicle 20 is a closed space, the smell inside the vehicle cabin of the vehicle 20 is less likely to change as compared with the outside of the vehicle cabin of the vehicle 20. The vehicle 20 can be used by various users in the car sharing service. Moreover, the user's preference for smell can vary from user to user. Therefore, depending on the user who used the vehicle 20 before, the user who uses the vehicle 20 later may feel uncomfortable or comfortable with the smell in the vehicle cabin of the vehicle 20. For example, suppose that a user who has used the vehicle 20 before has smoked a cigarette in the vehicle cabin of the vehicle 20. In this case, when the user who uses the vehicle 20 later dislikes the smell of cigarettes, the user who uses the vehicle 20 later may feel uncomfortable due to the smell of cigarettes remaining in the vehicle 20. For example, suppose that a user who has used the vehicle 20 before has sprinkled air freshener in the vehicle cabin of the vehicle 20. In this case, when the user who uses the vehicle 20 later likes the smell of air fresheners, the user who uses the vehicle 20 later may feel comfortable due to the smell of air fresheners remaining in the vehicle 20.

The information processing device 30 can provide a platform for a car sharing service. The information processing device 30 can recommend a vehicle 20 having a smell of a high degree of preference to a user who has applied for the use of the vehicle 20 among the plurality of vehicles 20 by a process described later. With such a configuration, when the user uses the vehicle 20, the possibility that the user feels uncomfortable due to the smell of the vehicle 20 can be reduced. Further, when the user uses the vehicle 20, the possibility that the user feels comfortable due to the smell of the vehicle 20 can increase.

The information processing device 30 may be a dedicated computer configured to function as a server, a general-purpose personal computer, a cloud computing system, or the like.

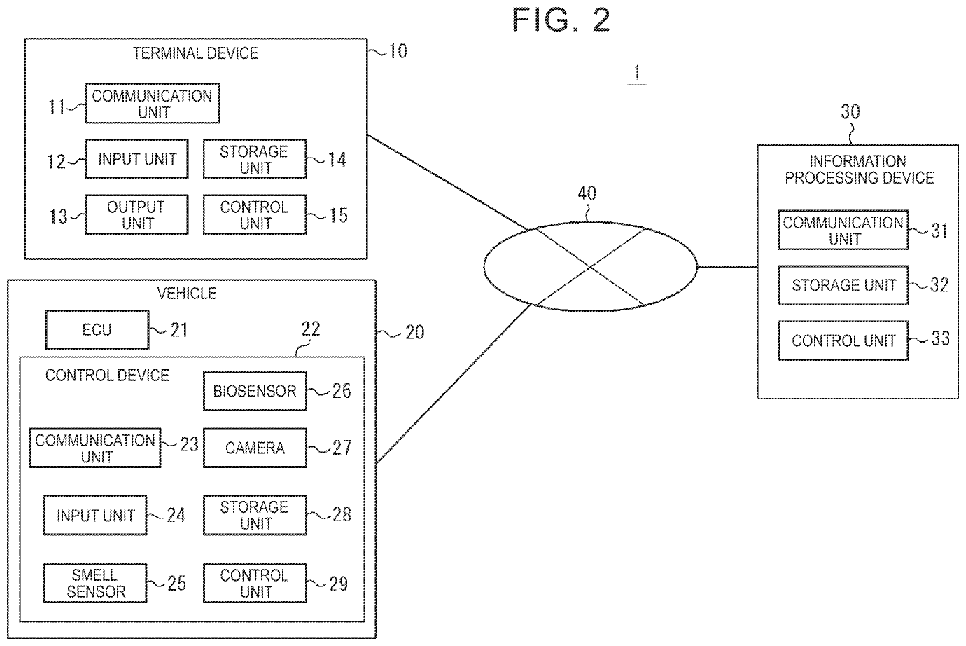

As shown in FIG. 2, the terminal device 10 includes a communication unit 11, an input unit 12, an output unit 13, a storage unit 14, and a control unit 15.

The communication unit 11 can include at least one communication module that can be connected to the network 40. The communication module is, for example, a communication module conforming to mobile communication standards such as the long term evolution (LTE), fourth generation (4G), or fifth generation (5G). The communication unit 11 may further include a module corresponding to short-range wireless communication such as Bluetooth (registered trademark). The communication unit 11 may further include a wireless communication module conforming to a non-contact communication standard. The non-contact communication standard may be a near field communication (NFC) standard.

The input unit 12 can accept input from the user. The input unit 12 may include at least one input interface capable of receiving input from the user. The input interface may be a physical key, a capacitive key, a pointing device, a touch screen integrated with a display, a microphone, or the like. The input unit 12 may be provided in the terminal device 10 or may be connected to the terminal device 10 as an external input device. When the input unit 12 is connected to the terminal device 10 as an external input device, the connection method between the input unit 12 and the terminal device 10 may be any connection method. The connection method is, for example, universal serial bus (USB), High-Definition Multimedia Interface (HDMI) (registered trademark), Bluetooth (registered trademark), or the like.

The output unit 13 can output data. The output unit 13 may include at least one output interface capable of outputting data. The output interface may be a display, a speaker, or the like. The display may be a liquid crystal display (LCD), an organic electroluminescence (EL) display, or the like. The output unit 13 may be provided in the terminal device 10 or may be connected to the terminal device 10 as an external output device. When the output unit 13 is connected to the terminal device 10 as an external output device, the connection method between the output unit 13 and the terminal device 10 may be any connection method. The connection method is, for example, USB, HDMI (registered trademark), Bluetooth (registered trademark), or the like.

The storage unit 14 can include at least one semiconductor memory, at least one magnetic memory, at least one optical memory, or a combination of at least two of them. The semiconductor memory is, for example, a random access memory (RAM) or a read-only memory (ROM). The RAM is, for example, a static random access memory (SRAM) or a dynamic random access memory (DRAM). The ROM is, for example, an electrically erasable programmable read only memory (EEPROM). The storage unit 14 may function as a main storage device, an auxiliary storage device, or a cache memory. The storage unit 14 can store data used for the operation of the terminal device 10 and data obtained through the operation of the terminal device 10.

The control unit 15 can include at least one processor, at least one dedicated circuit, or a combination thereof. The processor is a general-purpose processor such as a central processing unit (CPU) or a graphics processing unit (GPU), or a dedicated processor specialized for a specific process. The dedicated circuit is, for example, a field-programmable gate array (FPGA) or an application-specific integrated circuit (ASIC). The control unit 15 can perform the processes related to the operation of the terminal device 10 while controlling each unit of the terminal device 10.

The function of the terminal device 10 can be realized by executing the terminal control program according to the present embodiment with the processor corresponding to the control unit 15. That is, the function of the terminal device 10 can be realized by software. The terminal control program can cause the computer to perform the operation of the terminal device 10 so that the computer functions as the terminal device 10. That is, the computer can function as the terminal device 10 by performing the operation of the terminal device 10 according to the terminal control program.

In the present disclosure, the “program” can be recorded on a computer-readable non-transitory recording medium. The computer-readable non-transitory recording medium is, for example, a magnetic recording device, an optical disc, an opto-magnetic recording medium, or a ROM. The distribution of the program is carried out, for example, by selling, transferring, or renting a portable recording medium such as a digital versatile disc (DVD) or a compact disc read only memory (CD-ROM) on which the program is recorded. The program may be stored in the storage of the server. The program stored in the storage of the server may be distributed by being transferred to another computer. The program may be provided as a program product.

In the present disclosure, for example, the “computer” can temporarily store a program recorded on a portable recording medium or a program transferred from the server in a main storage device. In addition, the computer can cause the processor to read the program stored in the main storage device and cause the processor to perform processes according to the read program. The computer may read the program directly from the portable recording medium and perform processes according to the program. The computer may perform the processes according to the received program each time the program is transferred from the server to the computer. The computer may execute the processes with a so-called application service provider (ASP) type service that realizes the function only by the execution command and the result acquisition without transferring the program from the server to the computer. The program can include information that is used for processing by electronic computers and that is equivalent to a program. For example, data that is not a direct command to a computer but has the property of defining the processing of the computer corresponds to the “data equivalent to a program”.

A part or all of the functions of the terminal device 10 may be realized by a dedicated circuit corresponding to the control unit 15. That is, a part or all of the functions of the terminal device 10 may be realized by hardware.

The control unit 15 can receive the user input for applying for the use of the vehicle 20 by the input unit 12. This user input can be input from the input unit 12 by a user who wants to apply for the use of the vehicle 20 in the car sharing service. This user input includes input of user's membership information and input of a desired date and time. The user's membership information includes, for example, the user's membership number and the like. The desired date and time includes a date when the user wants to use the vehicle 20, a time zone when the user wants to use the vehicle 20, and the like. The time zone in which the user wants to use the vehicle 20 may be a time zone from the time when the user wants to start using the vehicle 20 to the time when the user wants to end the use of the vehicle 20. Upon receiving this input, the control unit 15 generates application information. The application information may include the user's membership information and information of the desired date and time. The control unit 15 transmits the generated application information to the information processing device 30 via the network 40 by the communication unit 11.

After transmitting the application information, the control unit 15 can receive recommendation information from the information processing device 30 via the network 40 by the communication unit 11. As will be described later, the recommendation information may include information of the vehicle 20 to be recommended to the user and the like. The control unit 15 causes the output unit 13 to output the received recommendation information. By outputting the recommendation information from the output unit 13, the user can grasp the recommendation information. When the user decides to use the recommended vehicle 20, the user inputs an input indicating the decision to use the recommended vehicle 20 via the input unit 12. When the control unit 15 receives the input indicating the decision of use by the input unit 12, the control unit 15 may transmit a notification indicating the decision to use the vehicle 20 to the information processing device 30 via the network 40 by the communication unit 11. After transmitting the notification indicating the decision to use the vehicle 20, the control unit 15 can receive reservation information from the information processing device 30 via the network 40 by the communication unit 11. As will be described later, the reservation information may include a notification indicating the completion of the reservation, information on the reservation date and time, and the like. The control unit 15 causes the output unit 13 to output the reservation information. After that, the user can use the vehicle 20 at the reservation date and time.

The control unit 15 can receive an input indicating the user's degree of preference for the smell of the vehicle 20 by the input unit 12. This input is input from the input unit 12 by the user who is in the vehicle 20 or by the user that has gotten off the vehicle 20. This input may be an input indicating the user's evaluation of the smell of the vehicle 20. When the control unit 15 receives this input by the input unit 12, the control unit 15 may transmit the input information indicating the user's degree of preference for the smell of the vehicle 20 to the information processing device 30 via the network 40 by the communication unit 11.

As shown in FIG. 2, the vehicle 20 includes an electronic control unit (ECU) 21 and a control device 22. The ECU 21 and the control device 22 are communicably connected to each other. The control device 22 includes a communication unit 23, an input unit 24, a smell sensor 25, a biosensor 26, a camera 27, a storage unit 28, and a control unit 29. The storage unit 28 and the control unit 29 may be a part of the ECU 21.

The ECU 21 can control the in-vehicle equipment mounted on the vehicle 20. The in-vehicle equipment may include equipment that can be operated by the user. The in-vehicle equipment that can be operated by the user is, for example, a vehicle window opening and closing device, an air-conditioning device for the vehicle cabin, a device for adjusting the inclination of the seat, an audio device, and the like. The ECU 21 can control the in-vehicle device based on the user operation.

The communication unit 23 may be configured in the same manner as the configuration of the communication unit 11. Similar to the configuration of the communication unit 11, the communication unit 23 may further include a communication module corresponding to short-range wireless communication. Similar to the configuration of the communication unit 11, the communication unit 23 may further include a wireless communication module corresponding to the non-contact communication standard.

The input unit 24 may be configured in the same manner as the configuration of the input unit 12. The input unit 24 may be provided in the vehicle 20. Similar to the input unit 12, the input unit 24 may be connected to the vehicle 20 as an external input device.

The smell sensor 25 can detect the smell of the vehicle 20. The smell detection may be the detection of at least one of the types of substances constituting the smell and concentrations of substances constituting the smell. The smell sensor 25 outputs the smell detection result of the vehicle 20 to the control unit 29. The smell sensor 25 may be arranged at any position where the smell of the vehicle 20 can be detected. The place where the smell sensor 25 is arranged may be a place where the smell sensor 25 can detect a smell that is likely to be smelled by a user who is using the vehicle 20. In general, a user using the vehicle 20 is likely to smell the vehicle cabin of the vehicle 20. The smell sensor 25 may be arranged at a position where the smell in the vehicle cabin of the vehicle 20 can be detected.

The biosensor 26 can detect the user's biometric information. The biosensor 26 outputs the detection result to the control unit 29. The biometric information may be at least one of a pulse rate, a blood pressure, and a respiratory rate. The biosensor 26 may be at least one of a pulse sensor capable of detecting a pulse rate, a blood pressure sensor capable of detecting a blood pressure, and a respiratory sensor capable of detecting a respiratory rate. The biosensor 26 may be arranged at any place where the biometric information of the driver as a user can be detected. For example, in the case of a pulse sensor, the biosensor 26 may be arranged on the driver's seat of the vehicle 20 as shown in FIG. 1.

The camera 27 can capture a user's face image. The camera 27 outputs the user's face image to the control unit 29. The camera 27 may be arranged at any place where the user's face image can be captured. When capturing a facial image of the driver as a user, the camera 27 may be arranged on the dashboard of the vehicle 20 as shown in FIG. 1.

The storage unit 28 may be configured in the same manner as the configuration of the storage unit 14. The storage unit 28 stores data used for the operation of the vehicle 20 and data obtained by the operation of the vehicle 20.

The control unit 29 may be configured in the same manner as the configuration of the control unit 15. The control unit 29 can perform the processes related to the operation of the vehicle 20 while controlling each unit of the vehicle 20.

The function of the control device 22 is realized by executing the vehicle control program according to the present embodiment with the processor included in the control unit 29. That is, the function of the control device 22 can be realized by software.

The vehicle control program is a program for causing a computer to execute a process of a step included in the operation of the control device 22 so that the computer can realize a function corresponding to the process of the step. That is, the vehicle control program is a program for causing the computer to function as the control device 22.

A part or all of the functions of the control device 22 may be realized by a dedicated circuit included in the control unit 29. That is, a part or all of the functions of the control device 22 may be realized by hardware.

The control unit 29 locks the door of the vehicle 20 while the vehicle 20 is on standby at the station. Here, when starting to use the vehicle 20 on standby at the station, the user can hold the non-contact integrated circuit (IC) type membership card or the communication unit 11 of the terminal device 10 over the communication unit 23. When the user holds the membership card or the communication unit 11 of the terminal device 10 over the communication unit 23, the control unit 29 can read the user's membership information from the membership card or the terminal device 10 by the communication unit 23. When the control unit 29 reads the user's membership information by the communication unit 23, the control unit 29 unlocks the door of the vehicle 20. When the door of the vehicle 20 is unlocked, the control unit 29 may transmit a notification indicating the start of use of the vehicle 20 and the user's membership information to the information processing device 30 via the network 40 by the communication unit 23.

When the user finishes using the vehicle 20, the control unit 29 can read the user's membership information by the communication unit 23. Here, when the user ends the use of the vehicle 20, the user can hold the membership card or the communication unit 11 of the terminal device 10 over the communication unit 23. When the user holds the membership card or the communication unit 11 of the terminal device 10 over the communication unit 23, the control unit 29 can read the user's membership information from the membership card or the terminal device 10 by the communication unit 23. When the control unit 29 reads the user's membership information by the communication unit 23, the control unit 29 changes the state of the door of the vehicle 20 from the unlocked state to the locked state. When the door of the vehicle 20 is locked from the unlocked state, the control unit 29 may transmit a notification indicating the end of use of the vehicle 20 and the user's membership information to the information processing device 30 via the network 40 by the communication unit 23.

The control unit 29 can acquire the smell detection result of the vehicle 20 from the smell sensor 25. The control unit 29 may transmit the smell detection result of the vehicle 20 to the information processing device 30 via the network 40 by the communication unit 23. The control unit 29 may transmit the smell detection result of the vehicle 20 to the information processing device 30 at preset time intervals. The time interval may be appropriately set in consideration of the average time of the user using the vehicle 20. Further, the control unit 29 may receive a notification from the information processing device 30 via the network 40 requesting the transmission of the smell detection result by the communication unit 31. Upon receiving the notification requesting this transmission, the control unit 29 may transmit the smell detection result of the vehicle 20 to the information processing device 30.

The control unit 29 can acquire an input indicating the user's degree of preference for the smell of the vehicle 20 by the input unit 24. This input can be input from the input unit 24 by the user who is in the vehicle 20. This input may be an input indicating the user's evaluation of the smell of the vehicle 20 as a degree of preference. When the control unit 29 acquires this input, the control unit 29 may acquire the smell detection result of the vehicle 20 from the smell sensor 25. The control unit 29 may transmit the acquired smell detection result of the vehicle 20 and the acquired input information indicating the user's degree of preference for the smell of the vehicle 20 to the information processing device 30 via the network 40 by the communication unit 23.

The control unit 29 can acquire information indicating the state of the in-vehicle device from the ECU 21. The control unit 29 may transmit the acquired information indicating the state of the in-vehicle device to the information processing device 30 via the network 40 by the communication unit 23.

The control unit 29 can acquire the user's biometric information from the biosensor 26. The control unit 29 may transmit the user's biometric information to the information processing device 30 via the network 40 by the communication unit 23. The control unit 29 may transmit the user's biometric information to the information processing device 30 at preset time intervals during a usage period described later. The time interval may be appropriately set in consideration of the time interval in which the user's biometric information can change.

The control unit 29 can acquire a user's face image from the camera 27. The control unit 29 may transmit the user's face image to the information processing device 30 via the network 40 by the communication unit 23. The control unit 29 may transmit the user's face image to the information processing device 30 at preset time intervals during the usage period described later. The time interval may be appropriately set in consideration of the time interval in which the user's face image can change.

As shown in FIG. 2, the information processing device 30 includes a communication unit 31, a storage unit 32, and a control unit 33.

The communication unit 31 can include at least one communication module that can be connected to the network 40. The communication module is, for example, a communication module conforming to a standard such as a wired local area network (LAN) or a wireless LAN.

The storage unit 32 may be configured in the same manner as the configuration of the storage unit 14. The storage unit 32 stores data used for the operation of the information processing device 30 and data obtained through the operation of the information processing device 30.

The control unit 33 may be configured in the same manner as the configuration of the control unit 15. The control unit 33 can perform processes related to the operation of the information processing device 30 while controlling various units of the information processing device 30.

The function of the information processing device 30 can be realized by executing the information processing program according to the present embodiment with the processor corresponding to the control unit 33. That is, the function of the information processing device 30 can be realized by software. The information processing program can cause the computer to function as the information processing device 30 by causing the computer to perform the operation of the information processing device 30. That is, the computer can function as the information processing device 30 by performing the operation of the information processing device 30 according to the information processing program.

A part or all of the functions of the information processing device 30 may be realized by a dedicated circuit corresponding to the control unit 33. That is, a part or all of the functions of the information processing device 30 may be realized by hardware.

The control unit 33 can receive the application information from the terminal device 10 via the network 40 by the communication unit 31. The application information may include the user's membership information and the information of the desired date and time as described above. The control unit 33 identifies the user who has applied for the use of the vehicle 20 based on the user's membership information. Further, the control unit 33 may select a vehicle 20 that is not reserved at the desired date and time among the plurality of vehicles 20 of the information processing system 1.

Determination Process of Recommended Vehicle

For example, when the control unit 33 selects a plurality of vehicles 20 that is not reserved at the desired date and time, the control unit 33 determines the vehicle 20 to be recommended to the user who has applied for the use of the vehicle 20 among the plurality of vehicles 20 based on the smell information and the preference information. The smell information is information indicating the classification of each smell of the plurality of vehicles 20. The preference information is information indicating the user's degree of preference for smells of a plurality of classifications. Based on such smell information and preference information, the control unit 33 can recommend the vehicle 20 having a smell of a high degree of preference to the user who has applied for the use of the vehicle 20.

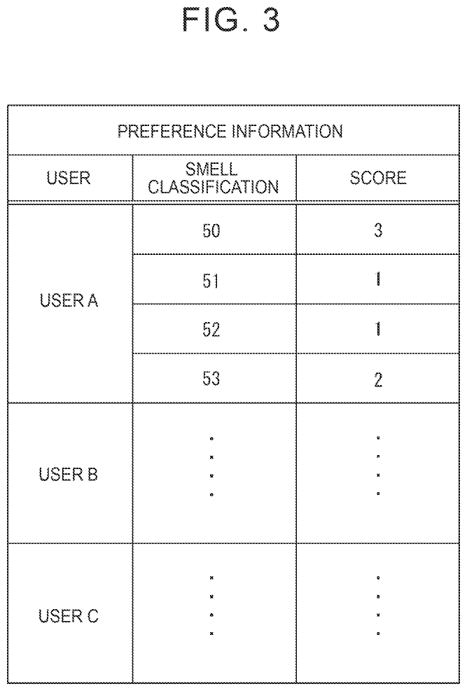

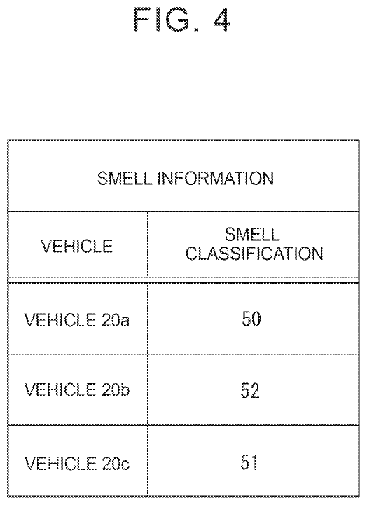

In the first embodiment, the control unit 33 determines the vehicle 20 to be recommended to the user who has applied for the use of the vehicle 20 among the plurality of vehicles 20 by collating the preference information as shown in FIG. 3 with the smell information as shown in FIG. 4.

In FIGS. 3 and 4, classifications 50, 51, 52, and 53 are examples of smell classifications. The smell classifications may be appropriately determined based on smells that can be identified by a general user. For example, the smell classifications may include the smell of cigarettes, the smell of air fresheners, aging body odor, the smell of garlic, or the like. The smell classifications may be appropriately determined based on the smells that can be identified by a general user and the intensity of the smells. The smell classifications may be defined by at least one of the types of substances constituting the smell and concentrations of substances constituting the smell.

As shown in FIG. 3, the preference information is information indicating the user's degree of preference for smells of a plurality of classifications. The degree of preference is a score indicating the degree to which the user prefers a certain classification of smells. In FIG. 3, it is shown that the higher the degree of preference of the smell, the more the user prefers the smell. The degree of preference of the user A for classification 50 is “3”. The degree of preference of the user A for classification 51 is “1”. The degree of preference of the user A for classification 52 is “1”. The degree of preference of the user A for classification 53 is “2”.

As shown in FIG.4, the smell information is information indicating the classification of each smell of the plurality of vehicles. In FIG. 4, the smell classification of the vehicle 20a is “50”. The smell classification of the vehicle 20b is “52”. The smell classification of the vehicle 20c is “51”.

When collating the preference information with the smell information, the control unit 33 may refer to the preference information as shown in FIG. 3 to identify the smell classification having the highest user's degree of preference. The control unit 33 may refer to the smell information as shown in FIG. 4 to determine whether there is a vehicle 20, among the plurality of vehicles 20 that is not reserved at the user's desired date and time, that belongs to the same smell classification as the smell classification having the highest user's degree of preference. When the control unit 33 determines that there is a vehicle 20 belonging to the same smell classification as the smell classification having the highest user's degree of preference, the control unit 33 may determine to recommend the vehicle 20. When the control unit 33 determines that there is no vehicle 20 belonging to the same smell classification as the smell classification having the highest user's degree of preference, the control unit 33 may determine to recommend a vehicle 20, among the plurality of vehicles 20 that is not reserved at the user's desired date and time, that belongs to a similar smell classification as the smell classification having the highest user's degree of preference. The similar smell classification may be appropriately determined according to factors such as the type of substance that defines the smell classification.

For example, suppose that the control unit 33 identifies the user A as a user who has applied for the use of the vehicle 20. Further, it is assumed that the vehicles 20 that are not reserved at the desired date and time of the user A are all of the vehicles 20a to 20b. In this case, the control unit 33 refers to the preference information as shown in FIG. 3 and identifies that the smell classification having the highest degree of preference of the user A is the classification 50. The control unit 33 refers to the smell information as shown in FIG. 4, and determines that there is the vehicle 20a belonging to the classification 50 from the vehicles 20a to 20b that are not reserved at the desired date and time of the user A. The control unit 33 determines to recommend the vehicle 20a to the user A.

For example, suppose that the control unit 33 identifies the user A as a user who has applied for the use of the vehicle 20. Further, it is assumed that the vehicles 20 that are not reserved at the desired date and time of the user A are the vehicles 20b and 20c. In this case, the control unit 33 refers to the smell information as shown in FIG. 4, and determines that there is no vehicle 20 belonging to the classification 50 from the vehicles 20b and 20c that are not reserved at the desired date and time of the user A. Here, it is assumed that the classification 50 and the classification 52 have similar smell classifications. In this case, the control unit 33 determines to recommend the vehicle 20b belonging to the classification 52 that is similar to the classification 50 to the user A from the vehicles 20b and 20c.

Transmission Process of Reservation Information

When the control unit 33 determines the vehicle 20 to be recommended, the control unit 33 generates the recommendation information. The recommendation information may include information of the vehicle 20 to be recommended to the user or the like. The control unit 33 transmits the generated recommendation information to the terminal device 10 via the network 40 by the communication unit 31. After transmitting the recommendation information, the control unit 33 may receive a notification indicating the decision to use the vehicle 20 from the terminal device 10 via the network 40 by the communication unit 31. When the control unit 33 receives the notification indicating the decision of use, the control unit 33 generates the reservation information. The reservation information may include a notification indicating the completion of the reservation, a reservation date and time, and the like. The control unit 33 transmits the generated reservation information to the terminal device 10 via the network 40 by the communication unit 31.

Generation or Update Process of Smell Information

The control unit 33 may receive the smell detection result of at least one vehicle 20 from the at least one vehicle 20 among the plurality of vehicles 20 via the network 40 by the communication unit 31. The control unit 33 determines the smell classification of the vehicle 20 based on the received smell detection result of the vehicle 20. The control unit 33 generates information indicating the smell classification of the vehicle 20 by associating the determined smell classification of the vehicle 20 with an identifier of the vehicle 20. For example, when the control unit 33 determines that the smell classification of the vehicle 20a is the classification 50, the control unit 33 generates information indicating the smell classification of the vehicle 20a by associating the identifier of the vehicle 20a with the classification 50.

The control unit 33 may generate or update at least a part of the smell information based on the generated information indicating the smell classification of the vehicle 20. When the generated information indicating the smell classification of the vehicle 20 does not exist in the smell information, the control unit 33 may include the generated information indicating the smell classification of the vehicle 20 in the smell information to generate at least a part of the smell information. When the generated information indicating the smell classification of the vehicle 20 already exists in the smell information, the control unit 33 may use the generated information indicating the smell classification of the vehicle 20 to update at least a part of the smell information. For example, the control unit 33 replaces the existing information indicating the smell classification of the vehicle 20 with the generated information indicating the smell classification of the vehicle 20 in the smell information to update a part of the smell information.

The control unit 33 may determine the recommended vehicle 20 by collating the updated smell information with the preference information in the above-mentioned determination process of the recommended vehicle 20. Here, the smell in the vehicle cabin of the vehicle 20 may change, for example, every time the user who uses the vehicle 20 changes. By updating the smell information, the smell information can be information indicating the latest smell classification of the vehicle 20. Since the smell information becomes information indicating the latest smell classification of the vehicle 20, the control unit 33 can more accurately recommend the vehicle 20 having a smell that suits the user's preference.

The control unit 33 may receive the smell detection result of at least one vehicle 20 from the at least one vehicle 20 among the plurality of vehicles 20 at preset time intervals to generate or update at least a part of the smell information. As described above, the vehicle 20 can transmit the smell detection result of the vehicle 20 to the information processing device 30 at preset time intervals.

When the control unit 33 receives the application information by the communication unit 31 in the determination process of the recommended vehicle 20 described above, the control unit 33 may generate or update at least a part of the smell information. With such a configuration, the smell information can be updated immediately after the information processing device 30 receives the application information. Since the smell information is updated immediately after the information processing device 30 receives the application information, the control unit 33 can more accurately recommend the vehicle 20 having a smell that suits the user's preference. Here, when the control unit 33 receives the above-mentioned application information, the control unit 33 may transmit a notification requesting transmission of the smell detection result to the plurality of vehicles 20 via the network 40 by the communication unit 31. Upon receiving the above-mentioned application information with the notification requesting this transmission, the control unit 33 can receive the smell detection result of the at least one vehicle 20 from the at least one vehicle 20 among the plurality of vehicles 20.

Generation or Update Process of Preference Information

Hereinafter, the period during which the user is using the vehicle 20 is also described as a “usage period”. The control unit 33 may receive a notification indicating the start of use of the vehicle 20 and a notification indicating the end of use of the vehicle 20 from the vehicle 20 via the network 40 by the communication unit 31. The usage period may be regarded as a period from the transmission time of the notification indicating the start of use of the vehicle 20 to the transmission time of the notification indicating the end of use of the vehicle 20.

The control unit 33 may generate or update at least a part of the preference information based on the smell detection result of the vehicle 20 on which the user has boarded and the degree of preference estimated from reaction information indicating the user's reaction to the smell of the vehicle 20 on which the user has boarded. Here, the control unit 33 may consider the smell detection result of the vehicle 20 received during the usage period as the smell detection result of the vehicle 20 on which the user has boarded.

The control unit 33 may determine the smell classification of the vehicle 20 based on detection result regarded as the smell detection result of the vehicle 20 on which the user has boarded. The determined smell classification of the vehicle 20 may be regarded as the smell classification of the vehicle 20 on which the user has boarded. Hereinafter, an example of the user's reaction to the smell of the vehicle 20 on which the user has boarded will be described.

### EXAMPLE 1

The control unit 33 may use input information indicating an impression (“good”, “normal”, “bad”, etc.) of the smell of the vehicle 20 as the user's reaction to the smell of the vehicle 20 on which the user has boarded. This input information may be information input by the user while the user is in the vehicle 20 or after the user has gotten off the vehicle 20. When the control unit 33 receives the input information indicating the impression of the smell of the vehicle 20 from the vehicle 20 or the terminal device 10 during the usage period, this input information may be regarded as the information input by the user while the user is in the vehicle 20. Further, when the control unit 33 receives the input information indicating the impression of the smell of the vehicle 20 immediately after the time when the above-mentioned notification indicating the end of use is transmitted, this input information may be regarded as the information input by the user after the user has gotten off the vehicle 20. The input information indicating the impression of the smell of the vehicle 20 input while the user is in the vehicle 20 or after the user has gotten off the vehicle 20 may be regarded as the input information indicating the impression of the smell of the vehicle 20 on which the user has boarded.

The control unit 33 may generate or update at least a part of the preference information based on the smell classification of the vehicle 20 on which the user has boarded and the degree of preference estimated from the input information indicating the impression of the smell of the vehicle 20 input by the user.

For example, it is assumed that one of “good”, “normal”, and “bad” is used as the user's impression of the smell. In this case, the control unit 33 may assign a degree of preference to the determined smell classification of the vehicle 20 according to the user's impression of the smell of the vehicle 20. When the user's impression of the smell of the vehicle 20 is highly evaluated (“good”), the control unit 33 may assign a degree of preference with a higher score to the determined smell classification of the vehicle 20 than when the user's impression of the smell of the vehicle 20 is poorly evaluated (“normal” or “bad”). When the smell classification of the vehicle 20 to which the degree of preference is assigned does not exist in the preference information, the control unit 33 may include the smell classification of the vehicle 20 to which the degree of preference is assigned in the preference information to generate a part of the preference information. When the smell classification of the vehicle 20 to which the degree of preference is assigned already exists in the preference information, the control unit 33 may use the smell classification of the vehicle 20 to which the degree of preference is assigned to update a part of the preference information.

### EXAMPLE 2

As a user's reaction to the smell of the vehicle 20, the control unit 33 may use information indicating the state of the in-vehicle device of the vehicle 20 that can be operated by the user, which is acquired while the user is in the vehicle 20.

The control unit 33 can receive information indicating the state of the in-vehicle device from the vehicle 20 via the network 40. When the control unit 33 receives the information indicating the state of the in-vehicle device during the usage period, this information indicating the state of the in-vehicle device may be regarded as the user's reaction to the smell of the vehicle 20. As described above, the in-vehicle equipment that can be operated by the user is, for example, a vehicle window opening and closing device, an air-conditioning device for the vehicle cabin, a device for adjusting the inclination of the seat, an audio device, and the like.

The control unit 33 may estimate the user's degree of preference for the smell of the vehicle 20 on which the user has boarded from the information indicating the state of the in-vehicle device. The control unit 33 may generate or update at least a part of the preference information based on the smell classification of the vehicle 20 on which the user has boarded and the estimated degree of preference. When the information indicating the estimated degree of preference does not exist in the preference information, the control unit 33 may include the information indicating the estimated degree of preference in the preference information to generate a part of the preference information. When the information indicating the estimated degree of preference already exists in the preference information, the control unit 33 may use the information indicating the estimated degree of preference to update a part of the preference information. For example, the control unit 33 replaces the information indicating the user's degree of preference for the smell that already exists in the preference information with the information indicating the newly estimated degree of preference to update a part of the preference information.

For example, suppose that the in-vehicle device is a vehicle window opening and closing device. In this case, when the control unit 33 identifies that the vehicle window is open based on the information indicating the state of the vehicle window opening and closing device, the user's degree of preference for the smell may be estimated to be lower than that when the vehicle window is identified to be closed.

For example, suppose that the in-vehicle device is an air conditioning device for the vehicle cabin. In this case, when the control unit 33 identifies that the air conditioning device is in the outside air introduction mode based on the information indicating the state of the air conditioning device, the user's degree of preference for the smell may be estimated to be lower than that when the air conditioning device is identified to be in the internal air circulation mode.

### EXAMPLE 3

The control unit 33 may use the user's biometric information acquired while the user is in the vehicle 20 as the user's reaction to the smell of the vehicle 20. The control unit 33 can receive the user's biometric information from the vehicle 20 via the network 40 by the communication unit 31. When the control unit 33 receives the user's biometric information during the usage period, this user's biometric information may be regarded as the user's reaction to the smell of the vehicle 20. As described above, the user's biometric information may be at least one of a pulse rate, a blood pressure, and a respiratory rate.

The control unit 33 may estimate the user's degree of preference for the smell of the vehicle 20 on which the user has boarded from the user's biometric information. As in Example 2 described above, the control unit 33 may generate or update at least a part of the preference information based on the smell classification of the vehicle 20 on which the user has boarded and the estimated degree of preference.

For example, when the control unit 33 analyzes the user's biometric information and estimates that the user is relaxed, the user's degree of preference for the smell may be estimated to be higher than that when the user is estimated to be stressed.

### EXAMPLE 4

The control unit 33 may use the user's face image acquired while the user is in the vehicle 20 as the user's reaction to the smell of the vehicle 20. The control unit 33 can receive the user's face image from the vehicle 20 via the network 40 by the communication unit 31. When the control unit 33 receives the user's face image during the usage period, this user's face image may be regarded as the user's reaction to the smell of the vehicle 20.

The control unit 33 may estimate the user's degree of preference for the smell of the vehicle 20 on which the user has boarded from the user's face image. As in Example 2 described above, the control unit 33 may generate or update at least a part of the preference information based on the smell classification of the vehicle 20 on which the user has boarded and the estimated degree of preference.

For example, when the control unit 33 analyzes the user's face image and estimates that the user is relaxed, the user's degree of preference for the smell may be estimated to be higher than that when the user is estimated to be stressed.

Operation of Information Processing System

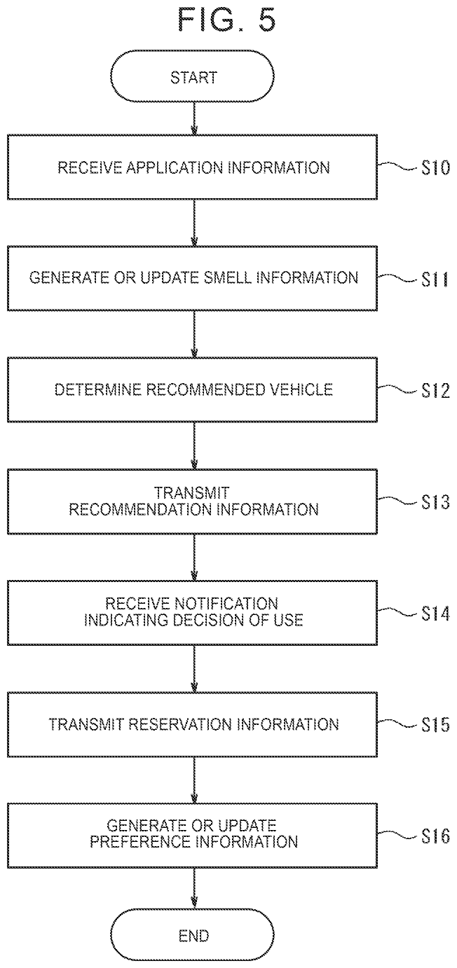

An example of the operation of the information processing system 1 shown in FIG. 1 will be described with reference to FIG. 5. The operation corresponds to an example of the information processing method according to the present embodiment.

The control unit 33 receives the application information from the terminal device 10 via the network 40 by the communication unit 31 (step S10). The control unit 33 generates or updates at least a part of the smell information (step S11). The control unit 33 collates the preference information and the smell information to determine the vehicle 20 to be recommended to the user who has applied for the use of the vehicle 20 (step S12). The control unit 33 transmits the recommendation information to the terminal device 10 via the network 40 by the communication unit 31 (step S13). The control unit 33 receives a notification indicating the decision to use the vehicle 20 from the terminal device 10 via the network 40 by the communication unit 31 (step S14). The control unit 33 transmits the reservation information to the terminal device 10 via the network 40 by the communication unit 31 (step S15). Subsequently, the user starts using the vehicle 20. The control unit 33 generates or updates at least a part of the preference information (step S16).

As described above, in the information processing system 1 according to the first embodiment, the information processing device 30 determines the vehicle 20 to be recommended to the user who has applied for the use of the vehicle 20 among the plurality of vehicles 20 based on the smell information and the preference information. With such a configuration, the information processing device 30 can recommend the vehicle 20 having a high degree of preference to the user who has applied for the use of the vehicle 20.

Therefore, according to the present embodiment, the convenience of the user can be improved.

### Second Embodiment

For example, when the control unit 33 selects a plurality of vehicles 20 that is not reserved at a desired date and time, the control unit 33 acquires the preference information by a machine-learned model. In this model, the user's degree of preference for the smell of the vehicle 20 is machine-learned so that the preference information is output when the smell information is input to the model. The model is provided for each user and is machine-learned for each user. The preference information output from the model indicates the degree of preference of the user who has applied for the use of the vehicle 20 for each smell of the plurality of vehicles 20.

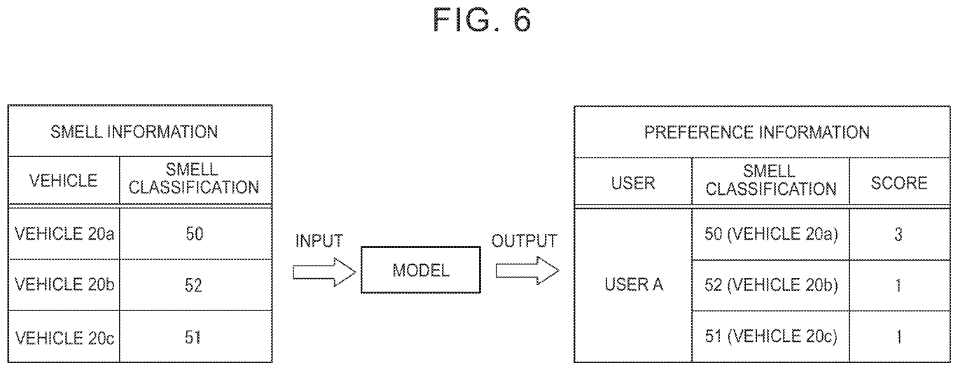

FIG. 6 is a diagram illustrating a concept of a model according to a second embodiment of the present disclosure. In FIG. 6, the control unit 33 identifies the user A as a user who has applied for the use of the vehicle 20. In this case, the control unit 33 inputs the smell information to the model of the user A. In FIG. 6, the smell information is the same as the smell information as shown in FIG. 4. When the smell information is input, the model outputs the preference information indicating the degree of preference for each smell of the vehicles 20a to 20c of the user A. That is, the model outputs the preference information indicating the degree of preference of the user A for the smell classifications 50 to 52.

The control unit 33 determines the vehicle 20 to be recommended to the user who has applied for the use of the vehicle 20 among the plurality of vehicles 20 based on the acquired preference information. The control unit 33 may determine to recommend the vehicle 20 belonging to the smell classification having the highest user's degree of preference based on the acquired preference information. In the impression information output from the model as shown in FIG. 6, it is assumed that the user A has the highest degree of preference for the classification 50. In this case, the control unit 33 determines to recommend the vehicle 20a belonging to the classification 50. For example, the control unit 33 prioritizes the vehicle 20a having a score of the degree of preference of “3” as shown in FIG. 6 over the vehicles 20b and 20c having scores of the degree of preference of “1” and determines the vehicle 20a as the vehicle 20 to be recommended to the user.

As in the first embodiment, the control unit 33 may receive the smell detection result of at least one vehicle 20 from the at least one vehicle 20 among the plurality of vehicles 20 by the communication unit 31. Upon receiving the smell detection result of the at least one vehicle 20, the control unit 33 may generate or update at least a part of the smell information. As in the first embodiment, upon receiving the above-mentioned application information by the communication unit 31, the control unit 33 may receive the smell detection result of at least one vehicle 20 from the at least one vehicle 20 among the plurality of vehicles 20. That is, as in the first embodiment, upon receiving the above-mentioned application information by the communication unit 31, the control unit 33 may generate or update at least a part of the smell information. In the second embodiment, the control unit 33 may input the updated smell information to the model when determining the recommended vehicle 20.

The control unit 33 may train the model using the smell information, the reaction information, and scores labeled on the reaction information as learning data. Such learning data can be supervised learning data. The reaction information may be as described above in the first embodiment. The control unit 33 can receive the reaction information from the vehicle 20 via the network 40 by the communication unit 31 together with information identifying the user. Labeling may be performed as appropriate, depending on the type of the reaction information. For example, when the user's biometric information is used as the reaction information, the biometric information indicating that the user is relaxed may be labeled with a higher score than the biometric information indicating that the user is stressed is. Each time the control unit 33 receives the reaction information, the reaction information may be labeled with a score, and the reaction information labeled with the score may be stored in the storage unit 32. When the amount of learning data stored in the storage unit 32 reaches a preset amount, the control unit 33 may train the model with the learning data. The preset amount may be appropriately selected depending on the machine learning algorithm adopted in the model.

Operation of Information Processing System

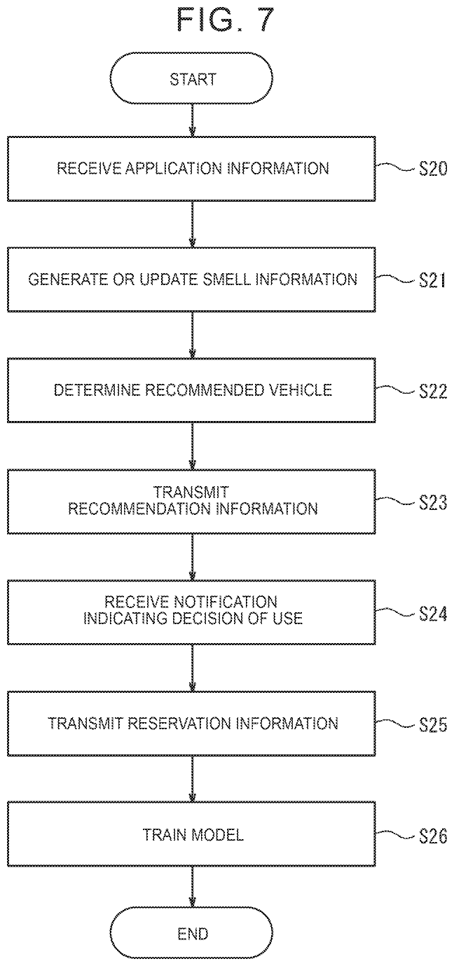

An example of the operation of the information processing system 1 according to the second embodiment will be described with reference to FIG. 7. The operation corresponds to an example of the information processing method according to the present embodiment.

The control unit 33 executes the processes of steps S20 and S21 in the same manner as the processes of steps S10 and S 11 shown in FIG. 5. The control unit 33 determines the recommended vehicle 20 based on the machine-learned model (step S22). The control unit 33 executes the processes of steps S23, S24, and S25 in the same manner as the processes of steps S13, S14, and S15 shown in FIG. 5. Subsequently, the user starts using the vehicle 20. The control unit 33 trains the model using the smell information, the reaction information, and the scores labeled on the reaction information as the learning data (step S26).

Other configurations and effects of the information processing system 1 according to the second embodiment are the same as those of the information processing system 1 according to the first embodiment.

The present disclosure is not limited to the embodiments described above. For example, blocks shown in the block diagram may be integrated, or a block may be divided. Instead of executing the steps shown in the flowcharts in chronological order according to the description, the steps may be executed in parallel or in a different order, depending on the processing capacities of the devices that execute the steps, or as necessary. Other changes may be made without departing from the scope of the present disclosure.

For example, in the embodiments described above, the information processing system 1 has been described as a system that provides a car sharing service. However, the information processing system 1 is not limited to a system that provides a car sharing service. The information processing system 1 may provide any service including a ride sharing service as long as it is a service that matches the user and the vehicle 20.

What is claimed is:

1. An information processing device, comprising:
a communication unit; and
a control unit that identifies, based on application information received by the communication unit for applying for use of a vehicle, a user that has applied for the use of the vehicle, and that determines a vehicle to be recommended to the user among a plurality of vehicles based on preference information and smell information, the preference information indicating a degree of preference of the user for a smell of a plurality of classifications, and the smell information indicating a smell classification of each of the vehicles.

2. The information processing device according to claim 1, wherein the control unit collates the preference information with the smell information to determine a vehicle to be recommended to the user among the vehicles.

3. The information processing device according to claim 2, wherein the control unit:
updates the smell information when the control unit receives a smell detection result of at least one vehicle among the vehicles from the at least one vehicle by the communication unit; and
collates the preference information with the smell information that is updated to determine a vehicle to be recommended to the user among the vehicles.

4. The information processing device according to claim 3, wherein when the control unit receives the application information by the communication unit, the control unit receives the smell detection result of the at least one vehicle from the at least one vehicle by the communication unit.

5. The information processing device according to claim 2, wherein the preference information includes a score indicating a degree to which the user prefers the smell of each of the classifications.

6. The information processing device according to claim 1, wherein the control unit generates or updates at least a part of the preference information based on a smell detection result of the vehicle on which the user has boarded and input information indicating the degree of preference of the user for the smell of the vehicle on which the user has boarded, the input information being input while the user is in the vehicle or after the user has gotten off the vehicle.

7. The information processing device according to claim 1, wherein the control unit generates or updates at least a part of the preference information based on a smell detection result of the vehicle on which the user has boarded and the degree of preference estimated from reaction information indicating a reaction of the user to the smell of the vehicle on which the user has boarded, the reaction being shown while the user is in the vehicle or after the user has gotten off the vehicle.

8. The information processing device according to claim 7, wherein the reaction information includes information indicating a state of an in-vehicle device that is operable by the user.

9. The information processing device according to claim 8, wherein the in-vehicle device includes at least one of a vehicle window opening and closing device and an air-conditioning device for a vehicle cabin.

10. The information processing device according to claim 7, wherein the reaction information includes biometric information of the user.

11. The information processing device according to claim 7, wherein the reaction information includes a face image of the user.

12. The information processing device according to claim 7, wherein the control unit receives the smell detection result of the vehicle on which the user has boarded and the reaction information from the vehicle on which the user has boarded by the communication unit.

13. The information processing device according to claim 1, wherein:
the control unit acquires the preference information by a model that is machine-learned and that outputs the preference information when the smell information is input; and
the preference information output from the model indicates the degree of preference of the user for each smell classification of the vehicles.

14. The information processing device according to claim 13, wherein the control unit:
updates the smell information when the control unit receives a smell detection result of at least one vehicle among the vehicles from the at least one vehicle by the communication unit; and
inputs the smell information that is updated to the model.

15. The information processing device according to claim 14, wherein when the control unit receives the application information by the communication unit, the control unit receives the smell detection result of the at least one vehicle from the at least one vehicle by the communication unit.

16. The information processing device according to claim 13, wherein:
the model assigns, as an output of the preference information, a score to each of the smell classifications of the vehicles such that the smell classification to which a high score is assigned indicates a higher degree of preference of the user compared to the smell classification to which a low score is assigned; and
the control unit preferentially determines a vehicle belonging to the smell classification to which the high score is assigned among the vehicles as a vehicle to be recommended to the user.

17. The information processing device according to claim 13, wherein the control unit trains the model using the smell information, reaction information indicating a reaction of the user to the smell of each of the vehicles, and scores labeled on the reaction information as learning data.

18. The information processing device according to claim 1, wherein the vehicles are a plurality of shared vehicles used for a car sharing service.

19. A program that causes a computer to perform operations including:
receiving application information for applying for use of a vehicle;
identifying a user who has applied for the use of the vehicle by the application information; and
determining a vehicle to be recommended to the user among a plurality of vehicles based on preference information and smell information, the preference information indicating a degree of preference of the user for a smell of a plurality of classifications, and the smell information indicating a smell classification of each of the vehicles.

20. An information processing method comprising:
receiving, by an information processing device, application information for applying for use of a vehicle;
identifying, by the information processing device, a user who has applied for the use of the vehicle by the application information; and
determining, by the information processing device, a vehicle to be recommended to the user among a plurality of vehicles based on preference information and smell information, the preference information indicating a degree of preference of the user for a smell of a plurality of classifications, and the smell information indicating a smell classification of each of the vehicles.
